(19) United States
(12) Patent Application Publication
(10) Pub. No.: US 2025/0036380 A1
(43) Pub. Date: Jan. 30, 2025

(54) METHOD AND APPARATUS FOR FUNCTION COMPILATION, MEDIUM, AND ELECTRONIC DEVICE

(71) Applicant: BEIJING ZITIAO NETWORK TECHNOLOGY CO., LTD., Beijing (CN)

(72) Inventor: Kailin Xu, Beijing (CN)

(21) Appl. No.: 18/759,566

(22) Filed: Jun. 28, 2024

(30) Foreign Application Priority Data
Jul. 25, 2023 (CN) 202310920339.2

(51) Int. Cl. G06F 8/41; G06F 8/35

(52) U.S. Cl. CPC G06F 8/42; G06F 8/35

(57) ABSTRACT

The disclosure relates to a method and apparatus for function compilation, a medium, and an electronic device, and relates to the technical field of computers. According to the method, according to a bracket identifier in an objective function to be compiled, a function body in the objective function and an argument called by the function body are determined; the objective function is compiled into an abstract syntax tree according to the function body and the argument; a computation result corresponding to the objective function is obtained based on the abstract syntax tree; a formula text character string sequence input by a user can be accurately compiled into an abstract syntax tree having semantics; and further the computation result of the objective function is computed based on the abstract syntax tree having the semantics.

### CROSS-REFERENCE TO RELATED APPLICATION(S)

This application claims priority to Chinese Application No. 202310920339.2 filed on Jul. 25, 2023, the disclosure of which is incorporated herein by reference in its entity.

### FIELD

The disclosure relates to the technical field of computers, and particularly relates to a method and apparatus for function compilation, a medium, and an electronic device.

### BACKGROUND

As formula computation functions are increasingly applied within a broad range, users can actively create self-defined function logic. However, computers generally do not support identification of the user-defined function logic under relevant syntax rules, which causes failure in function compilation.

### SUMMARY

The summary is provided such that concepts can be introduced in a simplified form, and these concepts will be described in detail later in the detailed description of embodiments. The summary is neither intended to identify key features or essential features of technical solutions, nor intended to limit the scope of the technical solutions.

In a first aspect, the disclosure provides a method for function compilation. The method includes:
acquiring an objective function to be compiled;
determining, according to a bracket identifier in the objective function, a function body in the objective function and an argument called by the function body;
compiling the objective function into an abstract syntax tree according to the function body and the argument, where the abstract syntax tree is configured to describe a parameter calling relation between the function body and the argument; and
obtaining a computation result corresponding to the objective function based on the abstract syntax tree.

In a second aspect, the disclosure provides an apparatus for function compilation. The apparatus includes:
an acquisition module configured to acquire an objective function to be compiled;
a determination module configured to determine, according to a bracket identifier in
the objective function, a function body in the objective function and an argument called by the function body;
a compilation module configured to compile the objective function into an abstract syntax tree according to the function body and the argument, where the abstract syntax tree is configured to describe a parameter calling relation between the function body and the argument; and
a computation module configured to obtain a computation result corresponding to the objective function based on the abstract syntax tree.

In a third aspect, the disclosure provides a computer-readable medium. The computer-readable medium stores a computer program. The program implements steps of the method described in the first aspect when executed by a processing unit.

In a fourth aspect, the disclosure provides an electronic device. The electronic device includes:
a storage unit storing a computer program; and
a processing unit configured to execute the computer program in the storage unit to implement steps of the method described in the first aspect.

Based on the above technical solutions, according to the bracket identifier in the objective function to be compiled, the function body in the objective function and the argument called by the function body are determined. The objective function is compiled into the abstract syntax tree according to the function body and the argument. The computation result corresponding to the objective function is obtained based on the abstract syntax tree. A formula text character string sequence input by a user can be accurately compiled into an abstract syntax tree having semantics. Further, the computation result of the objective function is computed based on the abstract syntax tree having the semantics. Based on the method for function compilation provided in the disclosure, semantics of the formula text character string sequence input by the user can be accurately identified in an online table or an online database table, and the objective function is compiled, based on the identified semantics, into the abstract syntax tree that can be directly used for computation such that the user can compile different formulas according to different requirements. Moreover, a degree of freedom of usage by the user is improved.

Other features and advantages of the disclosure will be described in detail in the detailed description of embodiments below.

### BRIEF DESCRIPTION OF THE DRAWINGS

The above and other features, advantages and aspects of various examples of the disclosure will become more apparent in combination with accompanying drawings and with reference to the following particular embodiments. The same or similar reference numerals refer to the same or similar elements throughout figures. It should be understood that the figures are illustrative, and components and elements are not necessarily drawn to scale. In the figures,

FIG. 1 is a flow diagram of a method for function compilation according to an example.

FIG. 2 is a detailed flow diagram of step 130 shown in FIG. 1.

FIG. 3 is a schematic diagram of an abstract syntax tree according to an example.

FIG. 4 is a detailed flow diagram of step 120 shown in FIG. 1.

FIG. 5 is a schematic diagram of an objective function according to an example.

FIG. 6 is a detailed flow diagram of step 140 shown in FIG. 1.

FIG. 7 is a schematic diagram of a scope stack according to an example.

FIG. 8 is a schematic diagram of a module connection of an apparatus for function compilation according to an example.

FIG. 9 is a schematic diagram of an electronic device according to an example.

### DETAILED DESCRIPTION OF EMBODIMENTS

Examples of the disclosure will be described in more detail below with reference to accompanying drawings. Although some examples of the disclosure are shown in accompanying drawings, it should be understood that the disclosure can be implemented in various forms and should not be construed as being limited to the examples stated herein. On the contrary, these examples are provided such that the disclosure can be understood more thoroughly and completely. It should be understood that accompanying drawings and examples of the disclosure are for exemplary purposes only and are not intended to limit the scope of protection of the disclosure.

It should be understood that various steps recited in method embodiments of the disclosure can be executed in different orders and/or in parallel. In addition, the method embodiments can include additional steps and/or omit to execute shown steps. The scope of the disclosure is not limited in this aspect.

The terms “comprise”, “include” and their variations are open-ended, that is, “comprising but not limited to” and “including but not limited to”. The term “based on” is “at least partially based on”. The term “an example” represents “at least one example”; the term “another example” represents “at least one other example”; and the term “some examples” represents “at least some examples”. Definitions of other terms will be given in the following descriptions.

It should be noted that concepts such as “first” and “second” mentioned in the disclosure are only used for distinguishing different apparatuses, modules or units, and are not intended to limit orders or interdependence relations of functions executed by these apparatuses, modules or units.

It should be noted that modifications of “a”, “an” or “plurality of” mentioned in the disclosure are illustrative rather than limiting, and those skilled in the art should understand that these modifications should be understood as “one or more”, unless explicitly stated otherwise in the context.

The names of messages or information exchanged between a plurality of apparatuses in embodiments of the disclosure are for illustrative purposes only, and are not intended to limit the scope of such messages or information.

The method for function compilation provided in an example of the disclosure is mainly used for a formula computation function in an online table or an online database table.

FIG. 1 is a flow diagram of a method for function compilation according to an example. As shown in FIG. 1, an example of the disclosure provides a method for function compilation. The method may be executed by an electronic device, and specifically may be executed by an apparatus for function compilation. The apparatus may be implemented by software and/or hardware, and is configured in the electronic device. As shown in FIG. 1, the method may include the following steps.

Step 110: acquire an objective function to be compiled.

Herein, the objective function to be compiled may refer to a function that is required to call an argument. Computation results of the objective function will be different according to different called arguments.

For instance, function=Lambda (x, y, Lambda (y, x+y) (x)) (123, 456) is required to call 123 and 456. For another instance, function=(LAMBDA (x, x+1)) (1) is required to call 1 in “(1)”.

It should be understood that the objective function is not certainly original function logic created by a user. For instance, the original function logic created by the user may be f (x, y)=x+y+1. The original function logic may be represented by a higher-order Lambda function. That is, the original function logic is represented as “=Lambda (x, y, x+y+1) (x, y)”. Accordingly, “=Lambda (x, y, x+y+1) (x, y)” is the objective function. Certainly, if a formula input by the user is “=Lambda (x, y, x+y+1) (x, y)”, input “=Lambda (x, y, x+y+1) (x, y)” is the objective function.

It is worth noting that the Lambda function is actually a reusable self-defined function created by using the Lambda function. After computation, the Lambda function returns a new anonymous function that can be computed, and supports computation of the anonymous function. The anonymous function is a function that has no specific name. For instance, a computation result of Lambda (x, x+1) is an anonymous function.

Step 120: Determine, according to a bracket identifier in the objective function, a function body in the objective function and an argument called by the function body.

Herein, the bracket identifier may refer to parentheses, square brackets, braces, etc. included in the objective function. It should be understood that the bracket identifier referred in the disclosure should be a pair of brackets. For instance, the bracket identifier may refer to “( )”.

The objective function is divided into a function body and an argument called by the function body by means of the bracket identifier in the objective function. For instance, in a case of objective function “=(LAMBDA (x, x+1)) (1)”, 1 in “(1)” is the argument called by function body “LAMBDA (x, x+1)”.

The function body refers to a function computation method for the objective function. The argument refers to a specific value that is required to be called by the function body of the objective function during computation.

It is worth noting that the function body in the objective function and the argument called by the function body are identified by means of the bracket identifier in the objective function. Different types of bracket identifiers in the objective function may be identified according to a preset syntax analysis algorithm. Then, the function body in the objective function and the argument called by the function body are determined according to the different types of bracket identifiers. The different types of bracket identifiers refer to semantics represented by the bracket identifiers in the objective function.

Step 130: compile the objective function into an abstract syntax tree according to the function body and the argument.

Herein, after the function body and the argument called by the function body are accurately identified in the objective function, the objective function is compiled into the abstract syntax tree based on a parameter calling relation between the function body and the argument. The abstract syntax tree is configured to describe the parameter calling relation between the function body and the argument.

It is worth noting that the abstract syntax tree (AST) is an abstract representation of a source code syntactic structure. The abstract syntax tree represents a syntactic structure of a programming language in a form of a tree. Each node on the abstract syntax tree represents a structure in the source code. For instance, a package, a type, a modifier, an operator, an interface, a return value and even a code annotation, etc. may be a syntactic structure.

Step 140: obtain a computation result corresponding to the objective function based on the abstract syntax tree.

Herein, the abstract syntax tree obtained by compiling the objective function is a formula variable instance that can be directly computed in a memory. Accordingly, the computation result corresponding to the objective function may be computed according to the abstract syntax tree.

Thus, according to the bracket identifier in the objective function to be compiled, the function body in the objective function and the argument called by the function body are determined. The objective function is compiled into the abstract syntax tree according to the function body and the argument. The computation result corresponding to the objective function is obtained based on the abstract syntax tree. A formula text character string sequence input by a user may be accurately compiled into an abstract syntax tree having semantics. Further, the computation result of the objective function is computed based on the abstract syntax tree having the semantics. Based on the method for function compilation provided in the disclosure, semantics of the formula text character string sequence input by the user can be accurately identified, and the objective function is compiled, based on the identified semantics, into the abstract syntax tree that can be directly used for computation such that the user can compile different formulas according to different requirements. Moreover, a degree of freedom of usage by the user is improved.

It is worth noting that the method for function compilation provided in an example of the disclosure can be configured to compile a Lambda function. Any function that is required to call an argument can be compiled through the method for function compilation provided in an example of the disclosure.

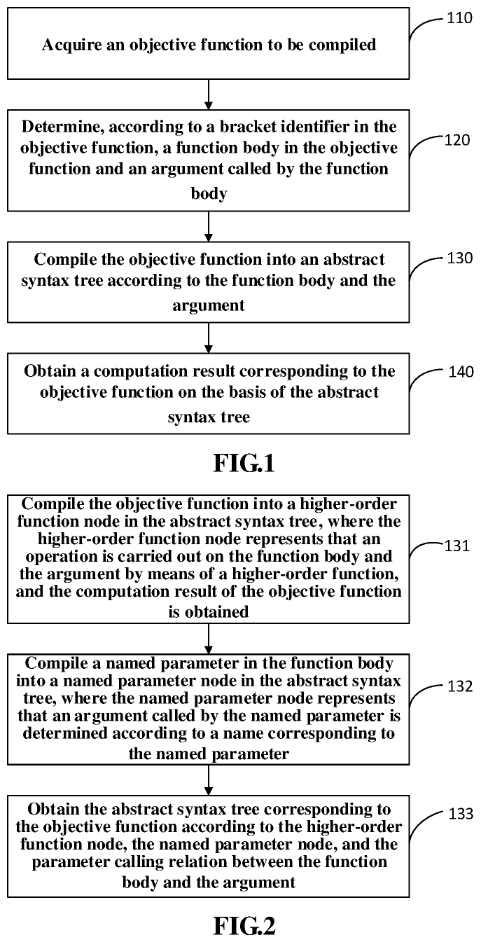

FIG. 2 is a detailed flow diagram of step 130 shown in FIG. 1. As shown in FIG. 2, the objective function may be compiled into the abstract syntax tree through the following steps.

Step 131: compile the objective function into a higher-order function node in the abstract syntax tree. The higher-order function node represents that an operation is carried out on the function body and the argument by means of a higher-order function, and the computation result of the objective function is obtained.

Herein, the higher-order function refers to a function that receives another function as an argument. The objective function may be parsed into a function operation variable that carries out an operation on the function body and the argument by means of the higher-order function. The function body and the argument serve as parameters of the higher-order function.

For instance, the objective function may be represented as “higher-order function [parameter 1, parameter 2]”, where parameter 1 is the argument, and parameter 2 is the function body. The function body represents a function computation method in the higher-order function, and the argument represents a parameter called by the function computation method. Therefore, an output result of the higher-order function is equivalent to the computation result of the objective function.

For instance, in a case of “=LAMBDA (x, x+1) (1)”, “=LAMBDA (x, x+1) (1)” may be represented as higher-order function [1, LAMBDA (x, x+1)].

On this basis, the objective function can be compiled into a higher-order function node in the abstract syntax tree. The higher-order function node represents that an operation is carried out on the function body and the argument by means of a higher-order function, and the computation result of the objective function is obtained. It is worth noting that the higher-order function node serves as a start point of abstract syntax.

Step 132: Compile a named parameter in the function body into a named parameter node in the abstract syntax tree. The named parameter node represents that an argument called by the named parameter is determined according to a name corresponding to the named parameter.

Herein, the named parameter is a parameter in a function that specifies a value of a particular parameter. That is, the named function is configured to introduce an argument. For instance, in a case of objective function “=LAMBDA (x, x+1) (1)”, x is the named parameter and is configured to introduce argument (1) into the LAMBDA (x, x+1) function.

The named parameter in the function body may be compiled into a named parameter node in the abstract syntax tree. The named parameter node represents that the argument called by the named parameter is obtained through querying according to a name corresponding to the named parameter. That is, a value of the named parameter node may be found in the argument according to the name corresponding to the named parameter.

For instance, in a case of “=LAMBDA (x, x+1) (1)”, named parameter x in x+1 is compiled as a named parameter node. When the named parameter node is executed, a value of the named parameter node is obtained by searching for an argument called by named parameter x in argument (1) according to the name of named parameter x.

It is worth noting that in a case that the function body includes a plurality of different named parameters, each named parameter is compiled into the named parameter node in the abstract syntax tree.

Step 133: obtain the abstract syntax tree corresponding to the objective function according to the higher-order function node, the named parameter node, and the parameter calling relation between the function body and the argument.

Herein, lexical parsing and syntax parsing may be carried out on the other syntax structures in the objective function according to preset grammar rules, such that the other syntax structures are respectively compiled into sub-nodes under a higher-order function node. The lexical parsing divides a code character string into minimum syntax unit arrays. The syntax parsing establishes a relation between syntax units based on lexical parsing of participles, and generates an abstract syntax tree by determining a relation between words and a meaning of a final expression of the words.

For instance, function body “LAMBDA (x, x+1)” in the higher-order function node may be compiled into a function body node that obtains a transportation result by carrying out an operation on parameter x and parameter x+1 by means of LAMBDA. Parameter x+1 may be compiled as an operator node that represents that the computation result is obtained by carrying out a numerical addition operation on parameter x and parameter 1. An argument in the higher-order function node is compiled into a numerical variable node in the abstract syntax tree. It should be understood that the inventive point of the method for function compilation provided in the disclosure mainly lies in that the function body and the argument are compiled into the higher-order function nodes, and the named parameter is compiled into the named parameter node. The other syntax structures in the objective function may be compiled according to compilation rules in the related art, which is not specifically limited in the disclosure.

The parameter calling relation between the function body and the argument reflects a calling relation between each parameter in the function body and the argument. By means of the parameter calling relation, the higher-order function node, the named parameter node and the other sub-nodes can be connected in series, such that the abstract syntax tree of the objective function is generated.

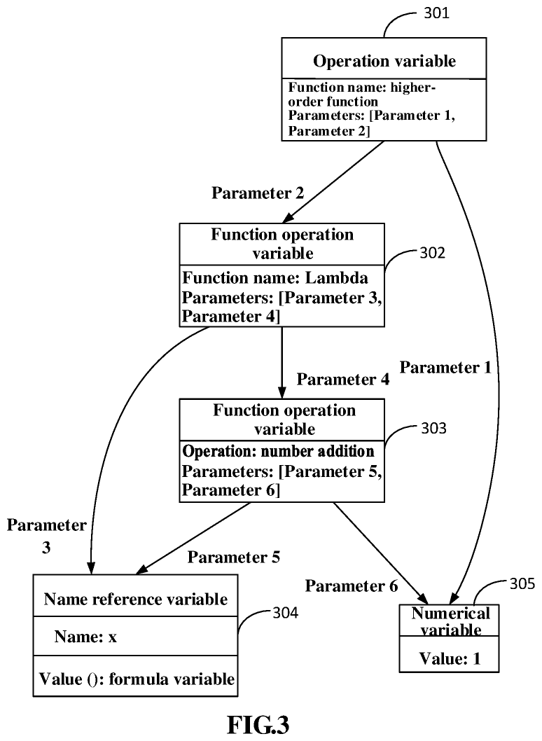

FIG. 3 is a schematic diagram of an abstract syntax tree according to an example. FIG. 3 shows an abstract syntax tree corresponding to objective function “=LAMBDA (x, x+1) (1)”. As shown in FIG. 3, “=LAMBDA (x, x+1) (1)” is entirely represented as a higher-order function node 301. The higher-order function node 301 carries out an operation on parameter 1 and parameter 2 by means of a higher-order function, and a computation result of the objective function is obtained. Parameter 1 is argument “(1)”, and parameter 2 is function body “LAMBDA (x, x+1)”. Further, in a case of parameter 2 in the higher-order function node 301, parameter 2 may be parsed into a function operation variable that carries out an operation on parameter x and parameter x+1 by means of the function body. That is, parameter 2 is compiled into a function body node 302 in the abstract syntax tree. The function body node 302 represents that an operation is carried out on a parameter included in the function body by means of a function corresponding to the function body, and a computation result corresponding to the function body is obtained. Parameter 2 is function body “LAMBDA (x, x+1)”, and the function body node may be represented as “LAMBDA [parameter 3, parameter 4]”. Parameter 3 is x, and parameter 4 is x+1. In a case of parameter 4 in the function body node 302, parameter 4 may be compiled into an operator node 303 in the abstract syntax tree. The operator node 303 represents that a digital addition operation is carried out on parameter 5 and parameter 6 included in parameter 4 by means of a binary operator. Parameter 5 is x, and parameter 6 is 1. In a case of an argument (parameter 1) in the higher-order function node 301, the argument is compiled into a numerical variable node 305. The numerical variable node 305 represents that a value of the argument is 1. Named parameter x in function body “LAMBDA (x, x+1)” in the function body node 302 is compiled into the named parameter node 304. The named parameter node 304 is a name reference variable, and a value corresponding to the named parameter is obtained by querying the argument according to the name of the named parameter. Finally, the higher-order function node 301, the function body node 302, the operator node 303, the named parameter node 304, and the numerical variable node 305 are connected according to the parameter calling relation between the function body and the argument, and the abstract syntax tree of the objective function is obtained.

Thus, by compiling the objective function into the higher-order function node and compiling the named parameter in the function body into the named parameter node, the formula text character string sequence input by the user can be accurately compiled into an abstract syntax tree having semantics, such that the computation result of the objective function is obtained based on the abstract syntax tree having the semantics.

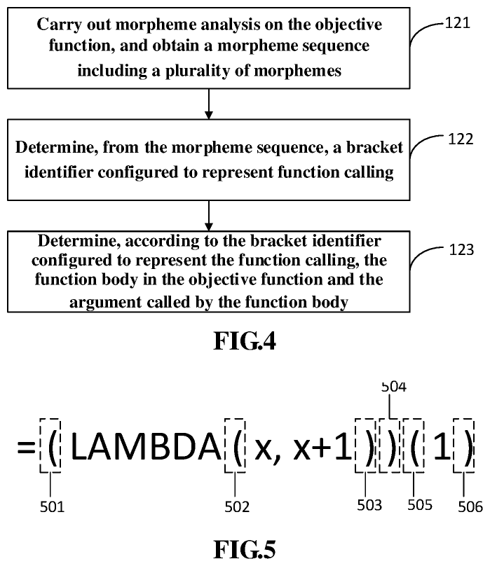

FIG. 4 is a detailed flow diagram of step 120 shown in FIG. 1. As shown in FIG. 4, step 120 may include the following steps.

Step 121: carry out morpheme analysis on the objective function, and obtain a morpheme sequence including a plurality of morphemes.

Herein, morphemes are basic units constituting words. By carrying out morpheme analysis on the objective function, the objective function can be split into a plurality of morphemes. Therefore, a morpheme sequence including a plurality of morphemes is obtained. For instance, in a case of objective function “=(LAMBDA (x, x+1)) (1)”, the morpheme sequence is “(, LAMBDA (,x,,,x,+,1,),), (, 1,)”.

Step 122: determine, from the morpheme sequence, a bracket identifier configured to represent function calling.

Herein, after the morpheme sequence is obtained, syntax analysis is required to be carried out on the morpheme sequence such that a meaning corresponding to each morpheme in the morpheme sequence can be determined.

The bracket identifier included in the objective function may have different types. The types of the bracket identifier may include a bracket operator, and a bracket identifier configured to represent function calling. The bracket operator may be configured to change priority of function computation and return a computation result in the bracket operator. Certainly, the bracket operator may also be configured to wrap a function. For instance, the bracket operator may wrap a Lambda function, which is represented as “(Lambda (x,x+1))”. The bracket identifier configured to represent function calling is a parameter configured to wrap the argument called by the objective function.

In a case of bracket identifier “( )” in the morpheme sequence, if a left side of the bracket identifier is not immediately followed by other contents, a type of the bracket identifier is a bracket operator. If the left side of the bracket identifier is immediately followed by other contents, the bracket identifier is a bracket identifier configured to represent function calling.

FIG. 5 is a schematic diagram of an objective function according to an example. As shown in FIG. 5, in a case of objective function “=(LAMBDA (x, x+1)) (1)”, a first left bracket 501 and a second right bracket 504 form a group of bracket identifiers. Since there is nothing else on a left side of the first left bracket 501, the first left bracket 501 and the second right bracket 504 form a group of bracket operators. The second left bracket 502 and the first right bracket 503 form a group of bracket identifiers. Since a left side of the second left bracket 502 is immediately followed by LAMBDA, the second left bracket 502 and the first right bracket 503 are bracket identifiers configured to represent function calling. A third left bracket 505 and a third right bracket 506 form a group of bracket identifiers. Since a left side of the third left bracket 505 is immediately followed by (LAMBDA (x, x+1)), the third left bracket 505 and the third right bracket 506 are bracket identifiers configured to represent function calling.

Certainly, it should be noted that some objective functions may have no bracket operator. For instance, objective function “=LAMBDA (x, x+1) (1)” have no bracket operator, but includes a bracket identifier configured to represent function calling.

The bracket identifier configured to represent function calling may be configured to distinguish between the function body in the objective function body and the argument called by the function body.

Step 123: determine, according to the bracket identifier configured to represent the function calling, the function body in the objective function and the argument called by the function body.

Herein, in a case that a parameter wrapped in the bracket identifier configured to represent function calling is a constant, a content located on a left side of the bracket identifier is determined as the function body of the objective function, and a parameter wrapped in the bracket operator configured to represent function calling is determined as an argument called by the function body.

For instance, in a case of objective function “=(LAMBDA (x, x+1)) (1)”, brackets in LAMBDA (x, x+1) are bracket identifiers configured to represent function calling, and brackets in (1) are also bracket identifiers configured to represent function calling. However, (1) wraps a constant, and 1 in (1) is an argument. Further, (LAMBDA (x, x+1)) is a function body corresponding to argument 1.

Thus, by determining the bracket identifier configured to represent function calling in the morpheme sequence of the objective function, and determining, according to the bracket identifier configured to represent function calling, the function body in the objective function and the argument called by the function body, accurate syntax analysis can be carried out on each morpheme of the objective function such that the function body in the objective function and the argument called by the function body can be accurately identified.

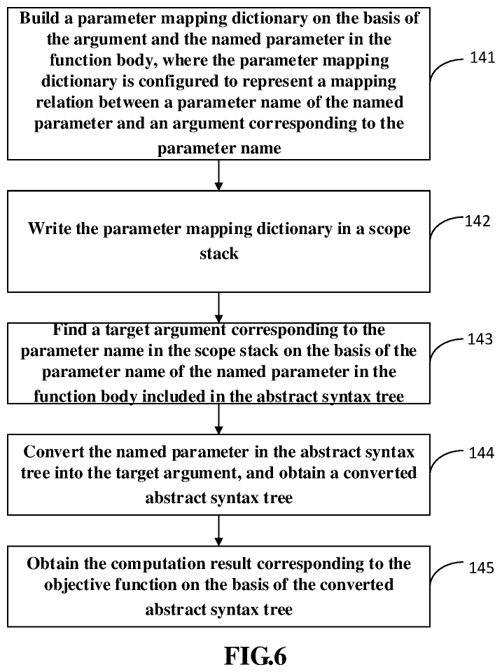

FIG. 6 is a detailed flow diagram of step 140 shown in FIG. 1. As shown in FIG. 6, step 140 may include the following steps.

Step 141: build a parameter mapping dictionary based on the argument and the named parameter in the function body, where the parameter mapping dictionary is configured to represent a mapping relation between a parameter name of the named parameter and an argument corresponding to the parameter name.

Herein, if N named parameters (equivalent to independent variables) are specified in the objective function, N arguments are also required to be introduced. Thus, N arguments may be saved in a parameter list, a mapping relation is established according to the parameter name corresponding to the named parameter in the objective function and the argument in the parameter list, and a parameter mapping dictionary is built.

For instance, a parameter mapping dictionary of objective function “=Lambda (last name, first name, “handsome thief” & last name & first name) (“Chu”, “Liuxiang”)” is as shown in Table 1.

TABLE 1

| Parameter name | Argument |
|---|---|
| Last name | “Chu” |
| First name | “Liuxiang” |

Step 142: write the parameter mapping dictionary in a scope stack.

Herein, each time the objective function is computed in a nested manner, the parameter mapping dictionary is saved in the scope stack of the objective function. After computation, the parameter mapping dictionary is removed from the scope stack. The scope stack refers to a set of an accessible variable, an object and a function.

Step 143: find a target argument corresponding to the parameter name in the scope stack based on the parameter name of the named parameter in the function body included in the abstract syntax tree.

Herein, when the named parameter in the abstract syntax tree is computed, a target argument corresponding to the parameter name is found in the scope stack according to the parameter name corresponding to the named parameter. For instance, in a case of named parameter “last name” in objective function “=Lambda (last name, first name, “handsome thief” & last name & first name) (“Chu”, “Liuxiang”)”, a target argument corresponding to named parameter “last name” found from the parameter mapping dictionary shown in Table 1 according to the parameter name corresponding to “last name” is “Chu”.

As shown in FIG. 3, when the named parameter node 304 is computed, according to the parameter name of named parameter “x”, a target argument corresponding to the named parameter “x” found in parameter mapping dictionary “x→1” is “1”.

In some examples, a search is carried out from a stack top of the scope stack along a stack bottom of the scope stack based on the parameter name. The target argument is determined according to a first found argument corresponding to a parameter name consistent with the parameter name.

When the target argument corresponding to the named parameter in the named parameter node is required to be obtained each time, a search is carried out from a stack top of the scope stack along a stack bottom of the scope stack based on the parameter name. A first found argument corresponding to a parameter name consistent with the parameter name of the named parameter is determined as the target argument. If no parameter name consistent with the parameter name of the named parameter is found, the search is continued towards the stack bottom of the scope stack.

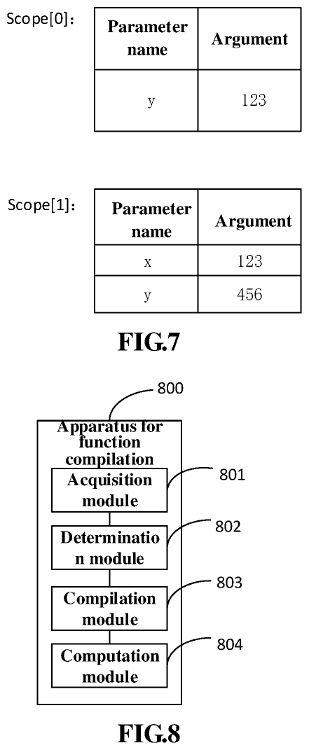

For instance, in a case of objective function “=Lambda (x, y, Lambda (y, x+y) (x)) (123, 456)”, the scope stack is as shown in FIG. 7 when Lambda (y, x+y) (x) is computed. When x+y is computed, named parameter y may be obtained at stack top (Scope [0]). That is, a value of named parameter y is 123. Named parameter x is obtained at stack bottom (Scope [1]). That is, a value of named parameter x is 123.

It is worth noting that by means of the scope stack, the found target argument corresponding to the named parameter can be ensured to be accurate. Even in complex nested computation, the found target argument can be ensured to be an argument actually called by the named parameter.

For instance, objective function “=Lambda (x, y, Lambda (y, x+y) (x)) (123,456)” uses Lambda in a nested manner. Lambda (y, x+y) (x) in “=Lambda (x, y, Lambda (y, x+y) (x)) (123,456)” may access named parameter x of outermost Lambda. In this regard, by means of the scope stack, the argument can be ensured to be accurately introduced.

Step 144: convert the named parameter in the abstract syntax tree into the target argument, and obtain a converted abstract syntax tree.

Herein, after the target argument corresponding to the named parameter is found, the named parameter in the abstract syntax tree may be converted into the target argument, and the converted abstract syntax tree is obtained.

For instance, in a case of objective function “=Lambda (last name, first name, “handsome thief” & last name & first name) (“Chu”, “Liuxiang”) “, computation ““handsome thief” & last name & first name” of “=Lambda (last name, first name, “handsome thief” & last name & first name) (“Chu”, “Liuxiang”)” may be converted into ““handsome thief” & Chu & Liuxiang”.

Step 145: obtain the computation result corresponding to the objective function based on the converted abstract syntax tree.

Herein, the converted abstract syntax tree may directly compute the computation result corresponding to the objective function, and the argument called by the named parameter is not required to be manually introduced during function computation.

Thus, through steps 141 and 145 mentioned above, the problem of a value of the named parameter of the objective function in a computation process can be solved by means of the scope stack such that the named parameter can obtained a correct argument for computation. Moreover, by converting the named parameter into the corresponding argument, the problem of a value of an independent variable of the objective function encountered in computation processes of other functions or operators can be solved such that the objective function can be accurately computed.

In some achievable embodiments, the abstract syntax tree may be serialized based on an inverse Polish expression in combination with a target serialization algorithm, a serialized object may be obtained, and the objective function may be transmitted based on the serialized object.

Herein, the target serialization algorithm is configured to describe the higher-order function in the higher-order function node in the abstract syntax tree as an ordinary function, for instance, describe the higher-order function in the higher-order function node as HOF. The target serialization algorithm is configured to describe the named parameter in the named parameter node as a target symbol, for instance, describe the named parameter as N.

For instance, the target serialization algorithm represents objective function “=LAMBDA (x,x+1) (1)” as a serialization result as shown in Table 2.

TABLE 2

| Serialization | | |
|---|---|---|
| result | Meaning | Describe |
| D1 | Number 1 | First parameter of higher- |
| | | order function F:HOF:2 |
| Nx | Name x | First parameter of Lambda |
| | | function F:LAMBDA:2 |
| Nx | Name x | First parameter of binary |
| | | addition operator OB+ |
| D1 | Number 1 | Second parameter of binary |
| | | addition operator OB+ |
| OB+ | Binary addition operator | Second parameter of Lambda |
| | | function F:LAMBDA:2 |
| F:LAMBDA:2 | Lambda function having | Second parameter of |
| | 2 parameters | higher-order function |
| | | F:HOF:2 |
| F:HOF:2 | Higher-order function | |
| | having 2 parameters | |

An inverse Polish expression (also referred to as a postfix expression) is an expression that places each operator after a computation object thereof. After each node of the abstract syntax tree is serialized through the target serialization algorithm, the serialization result may be described by means of an inverse Polish expression, and a serialized object corresponding to the objective function is obtained. Further, the objective function is transmitted to other electronic devices based on the serialized object.

It is worth noting that after receiving the serialized object, other electronic devices may deserialize the serialized object, and an abstract syntax tree for computation is obtained. It should be understood that deserialization may also be based on the above serialization algorithm.

Therefore, by serializing the abstract syntax tree, information of the objective function can be ensured to be completely described when data is transmitted. Even if the objective function includes a Lambda function, the objective function can be serialized and deserialized, and the information of the objective function can be ensured to be completely described. Deserialization may be rapidly carried out when a table is loaded or a formula is reloaded, such that a formula object instance is obtained.

In some achievable embodiments, syntax detection may be carried out on the objective function, and error reporting information may be output in a case that a syntax detection result represents that the objective function has an error.

Herein, the syntax detection may be carried out on the objective function before the objective function is compiled into the abstract syntax tree, and/or the syntax detection may be carried out on the objective function during computation based on the abstract syntax tree.

The step of carrying out syntax detection on the objective function includes at least one of:
detect whether the same parameter name exists in the objective function, and determine, in a case that the same parameter name exists in the objective function, that the syntax detection result represents that the objective function has the error;
detect whether a number of the named parameter included in the objective function is consistent with a number of the argument, and determine, in a case that the number of the named parameter is inconsistent with the number of the argument, that the syntax detection result represents that the objective function has the error; and
detect whether the objective function calls the argument, and determine that the syntax detection result represents that the objective function has an error in a case that the objective function does not call the argument.

Parameter names corresponding to different named parameters of the same Lambda function cannot be repeated, otherwise a value will be wrong. For instance, if a plurality of repeated parameter names “x” exist in objective function “=LAMBDA (x, x, x+x) (1, 2)”, objective function “=LAMBDA (x, x, x+x) (1, 2)” has the same parameter name. Error reporting information is output to remind a user that repeated parameter names exist in the objective function such that the user can correct the objective function.

A number of named parameters defined by the objective function should be consistent with a number of arguments. If the numbers are inconsistent, it is indicated that the objective function has an error. For instance, objective function “=LAMBDA (x, x+1) ( )” should have an argument, but objective function “=LAMBDA (x, x+1) ( )” has no argument, such that the number of the named parameter is inconsistent with the number of the argument. Error reporting information is output to remind the user that the number of the named parameter in the objective function is inconsistent with the number of the argument such that the user can correct the objective function.

The objective function should include the function body and the argument. If the objective function includes no calling argument, it is indicated that the objective function has an error. For instance, objective function “=LAMBDA (x, x+1)” should include argument calling, but objective function “=LAMBDA (x, x+1)” includes no argument calling, such that the objective function does not call the argument. Error reporting information is output to remind the user that the objective function does not call the argument such that the user can correct the objective function.

Therefore, by carrying out syntax detection on the objective function, comprehensive syntax detection can be carried out on compilation and/or computation of the objective function, such that accuracy of the objective function is ensured.

FIG. 8 is a schematic diagram of a module connection of an apparatus for function compilation according to an example. As shown in FIG. 8, an example of the disclosure provides an apparatus 800 for function compilation. The apparatus 800 for function compilation may include:
an acquisition module 801 configured to acquire an objective function to be compiled;
a determination module 802 configured to determine, according to a bracket identifier in the objective function, a function body in the objective function and an argument called by the function body;
a compilation module 803 configured to compile the objective function into an abstract syntax tree according to the function body and the argument, where the abstract syntax tree is configured to describe a parameter calling relation between the function body and the argument; and
a computation module 804 configured to obtain a computation result corresponding to the objective function based on the abstract syntax tree.

Optionally, the compilation module 803 includes:
a first compilation unit configured to compile the objective function into a higher-order function node in the abstract syntax tree, where the higher-order function node represents that an operation is carried out on the function body and the argument by means of a higher-order function, and the computation result of the objective function is obtained;
a second compilation unit configured to compile a named parameter in the function body into a named parameter node in the abstract syntax tree, where the named parameter node represents that an argument called by the named parameter is determined according to a name corresponding to the named parameter; and
a third compilation unit configured to obtain the abstract syntax tree corresponding to the objective function according to the higher-order function node, the named parameter node, and the parameter calling relation between the function body and the argument.

Optionally, the determination module 802 includes:
an analysis unit configured to carry out morpheme analysis on the objective function, and obtain a morpheme sequence including a plurality of morphemes;
a first determination unit configured to determine, from the morpheme sequence, a bracket identifier configured to represent function calling; and
a second determination unit configured to determine, according to the bracket identifier configured to represent the function calling, the function body in the objective function and the argument called by the function body.

Optionally, the computation module 804 includes:
a building unit configured to build a parameter mapping dictionary based on the argument and the named parameter in the function body, where the parameter mapping dictionary is configured to represent a mapping relation between a parameter name of the named parameter and an argument corresponding to the parameter name;
a write-in unit configured to write the parameter mapping dictionary in a scope stack;
a search unit configured to find a target argument corresponding to the parameter name in the scope stack based on the parameter name of the named parameter in the function body included in the abstract syntax tree;
a conversion unit configured to convert the named parameter in the abstract syntax tree into the target argument, and obtain a converted abstract syntax tree; and
a computation unit configured to obtain the computation result corresponding to the objective function based on the converted abstract syntax tree.

Optionally, the search unit is specifically configured to:
carry out a search from a stack top of the scope stack along a stack bottom of the scope stack based on the parameter name, and determine the target argument according to a first found argument corresponding to a parameter name consistent with the parameter name.

Optionally, the apparatus 800 for function compilation further includes:
a serialization module configured to serialize the abstract syntax tree based on an inverse Polish expression in combination with a target serialization algorithm, obtain a serialized object, and transmit the objective function based on the serialized object.

Optionally, the apparatus 800 for function compilation further includes:
a syntax detection module configured to carry out syntax detection on the objective function, and output error reporting information in a case that a syntax detection result represents that the objective function has an error.

The step of carrying out syntax detection on the objective function includes at least one of:
detect whether the same parameter name exists in the objective function, and determine, in a case that the same parameter name exists in the objective function, that the syntax detection result represents that the objective function has the error;
detect whether a number of the named parameter included in the objective function is consistent with a number of the argument, and determine, in a case that the number of the named parameter is inconsistent with the number of the argument, that the syntax detection result represents that the objective function has the error; and
detect whether the objective function calls the argument, and determine, in a case that the objective function does not call the argument, that the syntax detection result represents that the objective function has an error.

Logic of the method executed by each functional module in the apparatus 800 for function compilation may be obtained with reference to the part about the method in the above example, and will not be repeated herein.

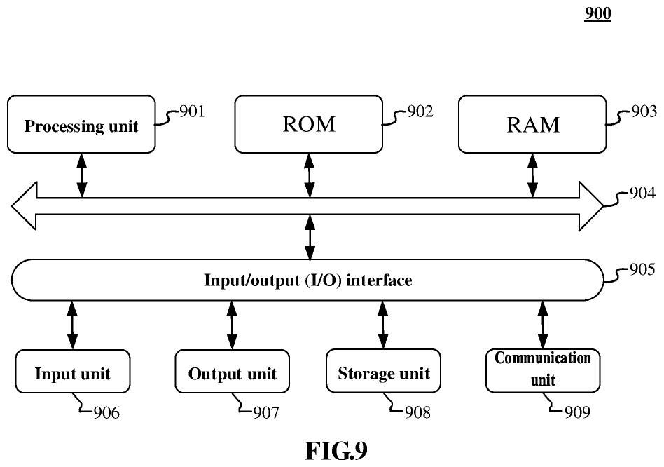

With reference to FIG. 9 below, a schematic structural diagram of an electronic device (such as a terminal device or a server) 900 applicable to implementing an example of the disclosure is shown in the figure. The terminal device in an example of the disclosure may include but is not limited to a mobile terminal such as a mobile phone, a notebook computer, a digital broadcast receiver, a personal digital assistant (PDA), a portable android device (PAD), a portable multimedia player (PMP), and an in-vehicle terminal (such as an in-vehicle navigation terminal), and a stationary terminal such as a digital television (TV) and a desktop computer. The electronic device shown in FIG. 9 is merely an instance, and should not bring any limitation on functions and usage scopes of examples of the disclosure.

As shown in FIG. 9, the electronic device 900 may include a processing unit (such as a central processing unit and a graphics processor) 901 that may execute various appropriate actions and processing according to programs stored in a read-only memory (ROM) 902 or loaded into a random-access memory (RAM) 903 from a storage unit 908. In the RAM 903, various programs and data required for operations of the electronic device 900 are further stored. The processing unit 901, the ROM 902 and the RAM 903 are connected to each other by means of a bus 904. An input/output (I/O) interface 905 is further connected to the bus 904.

Generally, the following apparatuses may be connected to the I/O interface 905: an input unit 906 including a touch screen, a touch pad, a keyboard, a mouse, a camera, a microphone, an accelerometer, a gyroscope, etc.; an output unit 907 including a liquid crystal display (LCD), a speaker, a vibrator, etc.; a storage unit 908 including a magnetic tape, a hard disk, etc.; and a communication unit 909. The communication unit 909 may allow the electronic device 900 to be in wireless or wired communication with other devices for data exchange. Although FIG. 9 shows an electronic device 900 having various apparatuses, it should be understood that not all of the shown apparatuses are required to be implemented or provided. More or fewer apparatuses may be alternatively implemented or provided.

In particular, according to an example of the disclosure, the process described above with reference to a flow diagram may be implemented as a computer software program. For instance, an example of the disclosure include a computer program product. The computer program product includes a computer program carried on a non-transitory computer-readable medium, and the computer program includes a program code for executing the method shown in the flow diagram. In such an example, the computer program may be downloaded and mounted from a network by means of the communication unit 909, mounted from the storage unit 908, or mounted from the ROM 902. When executed by the processing unit 901, the computer program executes the above functions defined in a method in an example of the disclosure.

It should be noted that the above computer-readable medium in the disclosure may be a computer-readable signal medium, a computer-readable storage medium, or any combinations thereof. The computer-readable storage medium may be but is not limited to an electronic, magnetic, optical, electromagnetic, infrared or semiconductor system, apparatus or device, or any combinations of the foregoing. More specific instances of the computer-readable storage medium may include but are not limited to an electrical connector having one or more wires, a portable computer disk, a hard disk, a random-access memory (RAM), a read-only memory (ROM), an erasable programmable read-only memory (EPROM or a flash memory), an optical fiber, a compact disc read-only memory (CD-ROM), an optical storage device, a magnetic storage device or any suitable combinations of the foregoing. In the disclosure, the computer-readable storage medium may be any tangible medium including or storing a program, and the program may be used by or in connection with an instruction execution system, apparatus or device. In the disclosure, a computer-readable signal medium may include a data signal propagated in a baseband or as part of a carrier wave, and a computer-readable program code is carried in the data signal. Such a propagated data signal may employ a plurality of forms, which include but are not limited to an electromagnetic signal, an optical signal or any suitable combinations of the foregoing. The computer-readable signal medium may also be any computer-readable medium rather than a computer-readable storage medium, and may send, propagate or transmit a program that is used by or in combination with an instruction execution system, apparatus or device. The program code included in the computer-readable medium may be transmitted by means of any appropriate media, which include but are not limited to a wire, an optical fiber cable, a radio frequency (RF), etc., or any suitable combinations of the foregoing.

In some embodiments, a terminal device and a server may carry out communication by means of any currently-known or future-developed network protocols such as a hyper text transfer protocol (HTTP), and may be interconnected to digital data communication (such as a communication network) of any forms or media. Instances of the communication network include a local area network (LAN), a wide area network (WAN), an internetwork (such as the internet), an end-to-end network (such as an ad hoc end-to-end network), and any currently-known or future-developed networks.

The above computer-readable medium may be included in the above electronic device, and may independently exist without being assembled into the electronic device.

The above computer-readable medium carries one or more programs. When the above one or more programs are executed by the electronic device, the electronic device is caused to acquire an objective function to be compiled; determine, according to a bracket identifier in the objective function, a function body in the objective function and an argument called by the function body; compile the objective function into an abstract syntax tree according to the function body and the argument, where the abstract syntax tree is configured to describe a parameter calling relation between the function body and the argument; and obtain a computation result corresponding to the objective function based on the abstract syntax tree.

The computer program code for executing an operation of the disclosure may be written in one or more programming languages or combinations thereof. The above programming languages include but are not limited to object oriented programming languages such as Java, Smalltalk and C++, and conventional procedural programming languages such as a “C” language or similar programming languages. The program code may be entirely executed on a user computer, partially executed on the user computer, executed as a stand-alone software package, partially executed on the user computer and partially executed on a remote computer, or entirely executed on the remote computer or a server. In a case involving the remote computer, the remote computer may be connected to the user computer by means of any type of network, which include a local area network (LAN) or a wide area network (WAN), or may be connected to an external computer (for instance, by means of the internet by an internet service provider).

Flow diagrams and block diagrams in figures show system architectures, functions and operations, which may be implemented according to systems, methods and computer program products in various examples of the disclosure. In this regard, each block in flow diagrams or block diagrams can represent a module, a program segment, or a part of a code, which include one or more executable instructions for implementing specified logical functions. It should also be noted that in some substitutive implementations, functions noted in blocks can also occur in sequences different from those in figures. For instance, functions represented by two continuous blocks can be executed substantially in parallel in practice, and sometimes implemented in reverse sequences, which depends on the involved functions. It should also be noted that each block in flow diagrams and/or block diagrams, and combinations of the blocks in the flow diagrams and/or the block diagrams can be implemented by means of dedicated hardware-based systems that execute specified functions or operations, or can be implemented by means of combinations of dedicated hardware and computer instructions.

Involved modules described in examples of the disclosure can be implemented in a form of software or hardware. In some cases, the name of a module does not constitute a limitation on the module itself.

At least part of the functions described above herein can be executed by one or more hardware logic components. For instance, without limitation, exemplary types of hardware logic components that may be used include a field programmable gate array (FPGA), an application specific integrated circuit (ASIC), an application specific standard product (ASSP), a system on a chip (SOC), a complex programmable logic device (CPLD), etc.

In a context of the disclosure, a machine-readable medium may be a tangible medium, which may include or store a program for being used by or in connection with an instruction execution system, apparatus or device. The machine-readable medium may be a machine-readable signal medium or a machine-readable c storage medium. The machine-readable medium may include but is not limited to an electronic, magnetic, optical, electromagnetic, infrared or semiconductor system, apparatus or device, or any suitable combinations of the foregoing. More specific instances of the machine-readable storage medium may include an electrical connection based on one or more wires, a portable computer disk, a hard disk, a random-access memory (RAM), a read-only memory (ROM), an erasable programmable read-only memory (EPROM or a flash memory), an optical fiber, a compact disk read-only memory (CD-ROM), an optical storage device, a magnetic storage device or any suitable combinations of the foregoing.

The above descriptions are only illustrative of preferred examples of the disclosure and employed technical principles. Those skilled in the art should understand that the scope involved in the disclosure is not limited to technical solutions formed by specific combinations of the above technical features, and should also cover other technical solutions formed by any combinations of the above technical features or their equivalent features without departing from the inventive concept, such as technical solutions formed by interchanging the above features and technical features having similar functions as disclosed (but not limited) in the disclosure.

In addition, although various operations are depicted in a specific order, it should not be understood that these operations are required to be executed in a shown specific order or in a sequential order. In certain circumstances, multitasking and parallel processing may be advantageous. Similarly, although several specific implementation details are included in the above discussion, these details should not be construed as limitations on the scope of the disclosure. Some features described in contexts of separate examples can also be implemented in a single example in combination. Conversely, various features described in a context of a single example can also be implemented in a plurality of examples separately or in any suitable sub-combinations.

Although the subject matter is described in language specific to structural features and/or methodological logical actions, it should be understood that the subject matter defined in the appended claims is not certainly limited to the specific features or actions described above. Conversely, the specific features and actions described above are merely instance forms for implementing the claims. A specific method for each module of the apparatus in the above examples to execute an operation is described in detail in examples related to this method, and will not be described in detail herein.

I/We claim:

1. A method for function compilation, comprising:
acquiring an objective function to be compiled;
determining, according to a bracket identifier in the objective function, a function body in the objective function and an argument called by the function body;
compiling, according to the function body and the argument, the objective function into an abstract syntax tree, wherein the abstract syntax tree is configured to describe a parameter calling relation between the function body and the argument; and
obtaining, based on the abstract syntax tree, a computation result corresponding to the objective function.

2. The method according to claim 1, wherein the compiling, according to the function body and the argument, the objective function into an abstract syntax tree comprises:
compiling the objective function into a higher-order function node in the abstract syntax tree, wherein the higher-order function node represents that an operation is carried out on the function body and the argument by means of a higher-order function, and the computation result of the objective function is obtained;
compiling a named parameter in the function body into a named parameter node in the abstract syntax tree, wherein the named parameter node represents that an argument called by the named parameter is determined according to a name corresponding to the named parameter; and
obtaining the abstract syntax tree corresponding to the objective function according to the higher-order function node, the named parameter node, and the parameter calling relation between the function body and the argument.

3. The method according to claim 1, wherein the determining, according to a bracket identifier in the objective function, a function body in the objective function and an argument called by the function body comprises:
carrying out morpheme analysis on the objective function, and obtaining a morpheme sequence comprising a plurality of morphemes;
determining, from the morpheme sequence, a bracket identifier configured to represent function calling; and
determining, according to the bracket identifier configured to represent the function calling, the function body in the objective function and the argument called by the function body.

4. The method according to claim 1, wherein the obtaining, based on the abstract syntax tree, a computation result corresponding to the objective function comprises:
building a parameter mapping dictionary based on the argument and the named parameter in the function body, wherein the parameter mapping dictionary is configured to represent a mapping relation between a parameter name of the named parameter and an argument corresponding to the parameter name;
writing the parameter mapping dictionary in a scope stack;
finding a target argument corresponding to the parameter name in the scope stack based on the parameter name of the named parameter in the function body comprised in the abstract syntax tree;
converting the named parameter in the abstract syntax tree into the target argument, and obtaining a converted abstract syntax tree; and
obtaining the computation result corresponding to the objective function based on the converted abstract syntax tree.

5. The method according to claim 4, wherein, the finding a target argument corresponding to the parameter name in the scope stack based on the parameter name of the named parameter in the function body comprised in the abstract syntax tree comprises:
carrying out a search from a stack top of the scope stack along a stack bottom of the scope stack based on the parameter name, and determining the target argument according to a first found argument corresponding to a parameter name consistent with the parameter name.

6. The method according to claim 1, further comprising:
serializing the abstract syntax tree based on an inverse Polish expression in combination with a target serialization algorithm, obtaining a serialized object, and transmitting the objective function based on the serialized object.

7. The method according to claim 1, further comprising:
carrying out syntax detection on the objective function, and outputting error reporting information in a case that a syntax detection result represents that the objective function has an error; wherein
the syntax detection comprises at least one of:
detecting whether the same parameter name exists in the objective function, and determining, in a case that the same parameter name exists in the objective function, that the syntax detection result represents that the objective function has the error;
detecting whether a number of the named parameter comprised in the objective function is consistent with a number of the argument, and determining, in a case that the number of the named parameter is inconsistent with the number of the argument, that the syntax detection result represents that the objective function has the error; and
detecting whether the objective function calls the argument, and determining, in a case that the objective function does not call the argument, that the syntax detection result represents that the objective function has the error.

8. A non-transitory computer-readable medium, storing a computer program, that when executed by a processor of a computer, causes the computer to:
acquire an objective function to be compiled;
determine, according to a bracket identifier in the objective function, a function body in the objective function and an argument called by the function body;
compile, according to the function body and the argument, the objective function into an abstract syntax tree, wherein the abstract syntax tree is configured to describe a parameter calling relation between the function body and the argument; and
obtain, based on the abstract syntax tree, a computation result corresponding to the objective function.

9. The non-transitory computer-readable medium according to claim 8, wherein the compiling, according to the function body and the argument, the objective function into an abstract syntax tree comprises:
compiling the objective function into a higher-order function node in the abstract syntax tree, wherein the higher-order function node represents that an operation is carried out on the function body and the argument by means of a higher-order function, and the computation result of the objective function is obtained;
compiling a named parameter in the function body into a named parameter node in the abstract syntax tree, wherein the named parameter node represents that an argument called by the named parameter is determined according to a name corresponding to the named parameter; and
obtaining the abstract syntax tree corresponding to the objective function according to the higher-order function node, the named parameter node, and the parameter calling relation between the function body and the argument.

10. The non-transitory computer-readable medium according to claim 8, wherein the determining, according to a bracket identifier in the objective function, a function body in the objective function and an argument called by the function body comprises:
carrying out morpheme analysis on the objective function, and obtaining a morpheme sequence comprising a plurality of morphemes;
determining, from the morpheme sequence, a bracket identifier configured to represent function calling; and
determining, according to the bracket identifier configured to represent the function calling, the function body in the objective function and the argument called by the function body.

11. The non-transitory computer-readable medium according to claim 8, wherein the obtaining, based on the abstract syntax tree, a computation result corresponding to the objective function comprises:
building a parameter mapping dictionary based on the argument and the named parameter in the function body, wherein the parameter mapping dictionary is configured to represent a mapping relation between a parameter name of the named parameter and an argument corresponding to the parameter name;
writing the parameter mapping dictionary in a scope stack;
finding a target argument corresponding to the parameter name in the scope stack based on the parameter name of the named parameter in the function body comprised in the abstract syntax tree;
converting the named parameter in the abstract syntax tree into the target argument, and obtaining a converted abstract syntax tree; and
obtaining the computation result corresponding to the objective function based on the converted abstract syntax tree.

12. The non-transitory computer-readable medium according to claim 11, wherein, the finding a target argument corresponding to the parameter name in the scope stack based on the parameter name of the named parameter in the function body comprised in the abstract syntax tree comprises:
carrying out a search from a stack top of the scope stack along a stack bottom of the scope stack based on the parameter name, and determining the target argument according to a first found argument corresponding to a parameter name consistent with the parameter name.

13. The non-transitory computer-readable medium according to claim 8, the computer is further caused to:
serialize the abstract syntax tree based on an inverse Polish expression in combination with a target serialization algorithm, obtaining a serialized object, and transmitting the objective function based on the serialized object.

14. The non-transitory computer-readable medium according to claim 8, the computer is further caused to:
carry out syntax detection on the objective function, and outputting error reporting information in a case that a syntax detection result represents that the objective function has an error; wherein
the syntax detection comprises at least one of:
detecting whether the same parameter name exists in the objective function, and determining, in a case that the same parameter name exists in the objective function, that the syntax detection result represents that the objective function has the error;
detecting whether a number of the named parameter comprised in the objective function is consistent with a number of the argument, and determining, in a case that the number of the named parameter is inconsistent with the number of the argument, that the syntax detection result represents that the objective function has the error; and
detecting whether the objective function calls the argument, and determining, in a case that the objective function does not call the argument, that the syntax detection result represents that the objective function has the error.

15. An electronic device, comprising:
a storage unit storing a computer program; and
a processing unit configured to execute the computer program in the storage unit to cause the electronic device:
acquire an objective function to be compiled;
determine, according to a bracket identifier in the objective function, a function body in the objective function and an argument called by the function body;
compile, according to the function body and the argument, the objective function into an abstract syntax tree, wherein the abstract syntax tree is configured to describe a parameter calling relation between the function body and the argument; and
obtain, based on the abstract syntax tree, a computation result corresponding to the objective function.

16. The electronic device according to claim 15, wherein the compiling, according to the function body and the argument, the objective function into an abstract syntax tree comprises:
compiling the objective function into a higher-order function node in the abstract syntax tree, wherein the higher-order function node represents that an operation is carried out on the function body and the argument by means of a higher-order function, and the computation result of the objective function is obtained;
compiling a named parameter in the function body into a named parameter node in the abstract syntax tree, wherein the named parameter node represents that an argument called by the named parameter is determined according to a name corresponding to the named parameter; and
obtaining the abstract syntax tree corresponding to the objective function according to the higher-order function node, the named parameter node, and the parameter calling relation between the function body and the argument.

17. The electronic device according to claim 15, wherein the determining, according to a bracket identifier in the objective function, a function body in the objective function and an argument called by the function body comprises:
carrying out morpheme analysis on the objective function, and obtaining a morpheme sequence comprising a plurality of morphemes;
determining, from the morpheme sequence, a bracket identifier configured to represent function calling; and
determining, according to the bracket identifier configured to represent the function calling, the function body in the objective function and the argument called by the function body.

18. The electronic device according to claim 15, wherein the obtaining, based on the abstract syntax tree, a computation result corresponding to the objective function comprises:
building a parameter mapping dictionary based on the argument and the named parameter in the function body, wherein the parameter mapping dictionary is configured to represent a mapping relation between a parameter name of the named parameter and an argument corresponding to the parameter name;
writing the parameter mapping dictionary in a scope stack;
finding a target argument corresponding to the parameter name in the scope stack based on the parameter name of the named parameter in the function body comprised in the abstract syntax tree;
converting the named parameter in the abstract syntax tree into the target argument, and obtaining a converted abstract syntax tree; and
obtaining the computation result corresponding to the objective function based on the converted abstract syntax tree.

19. The electronic device according to claim 15, the electronic device is further caused to:
serialize the abstract syntax tree based on an inverse Polish expression in combination with a target serialization algorithm, obtaining a serialized object, and transmitting the objective function based on the serialized object.

20. The electronic device according to claim 15, the electronic device is further caused to:
carry out syntax detection on the objective function, and outputting error reporting information in a case that a syntax detection result represents that the objective function has an error; wherein
the syntax detection comprises at least one of:
detecting whether the same parameter name exists in the objective function, and determining, in a case that the same parameter name exists in the objective function, that the syntax detection result represents that the objective function has the error;
detecting whether a number of the named parameter comprised in the objective function is consistent with a number of the argument, and determining, in a case that the number of the named parameter is inconsistent with the number of the argument, that the syntax detection result represents that the objective function has the error; and
detecting whether the objective function calls the argument, and determining, in a case that the objective function does not call the argument, that the syntax detection result represents that the objective function has the error.
